(19) United States
(12) Patent Application Publication
(10) Pub. No.: US 2010/0065701 A1
(43) Pub. Date: Mar. 18, 2010

(54) Archery bow holder with ground stand and work table mounting bar

(76) Inventor: Brockman Poe Fletcher, South Riding, VA (US)

Correspondence Address: BROCKMAN P FLETCER, 25576 ARTHUR PLACE, SOUTH RIDING, VA, 20152, US

(21) Appl. No.: 12/283,510

(22) Filed: Sep. 12, 2008

(51) Int. Cl. A01M 31/00; A47B 96/06

(52) U.S. Cl. 248/229.1; 211/85.7; 248/316.6

(57) ABSTRACT

The archery bow holder provides a mechanical means of supporting the bow when the bow is not being held by the archer during hunting, target shooting, or performing maintenance/tuning adjustments to the bow. The bow holder is made to be used in conjunction with; a commercially available hunter's tree stand, or as identified in this application a ground stand, or the work table mounting bar. The archery bow holder components may be made from a various mix of the following materials or from a single group of material; metal, alloy, or a group of synthetic or natural organic materials. During use the bow holder remains in the open position, ready to receive a bow until a bow limb is inserted into the bow holder and by the weight of the bow closes the arms. The mounting shaft and arm assembly can be rotated to hold and support the bow at various angles. The bow will remain in the bow holder until the archer lefts the bow and the arms open automatically allowing for an easy and quite removal of the bow in one single movement.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING

Not Applicable

### BACKGROUND OF THE INVENTION

For an archer using a bow during target practicing, or hunting, or tuning the bow the archer has had to depend on different equipment to properly secure the bow when the bow is not being held by the archer. Bow holding devices are not typically universal were the bow holder could be used in all situations for the archer. To meet this multifunctional requirement a bow holding device needs to be universal in that it can be used during target practice, hunting, and tuning. In addition while hunting, the archer needs to make as little movement as possible due to the close proximity of wild game. Many current bow holders for hunters require the hunter to make varying directional movements with their arm when placing the bow into and removing the bow from the holder. The proposed designs allows for a bow holder that can be used in varying situations and provide to the hunter a simple single movement of the archers arm to insert or remove the bow.

### BRIEF SUMMARY OF THE INVENTION

The archery's bow holder provides a means for an archer to secure the bow without having to support the bow by their hand. The bow holder is made to be used in various applications of hunting, target practicing, and bow tuning. The bow holder is made so it can be attached to conventional treestands on either the left side or right side and the bow holder will functionally operate the same on either side of the treestand. The bow holder can also be mounted to the ground stand bracket during ground target shooting/still hunting or by using a mounting bar the bow holder can be affixed to a work table during bow tuning/maintenance. The bow holder assembly is made such that after it is mounted, the bow holder can be rotated to provide various angles to position an archer's bow. The rotation is accomplished by losing a thumb bolt, rotating the mounting shaft, and then tightening the thumb bolt. The use of the bow holder and ground stand will allow the archer to keep the bow off of the ground when the archer is retrieving arrows during target practice and allow the archer to rest from holding the bow during still hunting. The work-table mounting bar allows the archer to secure the bow holder to any conventional table so the archer may perform tuning/maintenance on the bow.

Those objectives and other objectives of this invention will become apparent to those skilled in the art after reading the following specifications.

### BRIEF DESCRIPTION OF THE SEVERAL VIEWS OF THE DRAWINGS

FIG. 1 is a perspective view of the bow holder assembly with a round shaft and multiplex arm components.

FIG. 2 is a perspective view of the bow holder assembly with spline shaft and monolithic arms.

FIG. 3 is an exploded perspective of the bow holder rail bracket assembly.

FIG. 4 is a partial perspective view of the bow holder round shaft, arm assembly, and its exploded view to provide farther detail of the assembly.

FIG. 5 is a partial perspective view of the bow holder spline shaft, arm assembly, and its exploded view to provide farther clarification to the assembly.

FIG. 6 provides a perspective of the bow holder ground stand.

FIG. 7 provides a perspective view of the bow holder assembly installed on the ground stand.

FIG. 8 provides a perspective view of the bow holder assembly prior to being mounted on a conventional tree stand and bow installed.

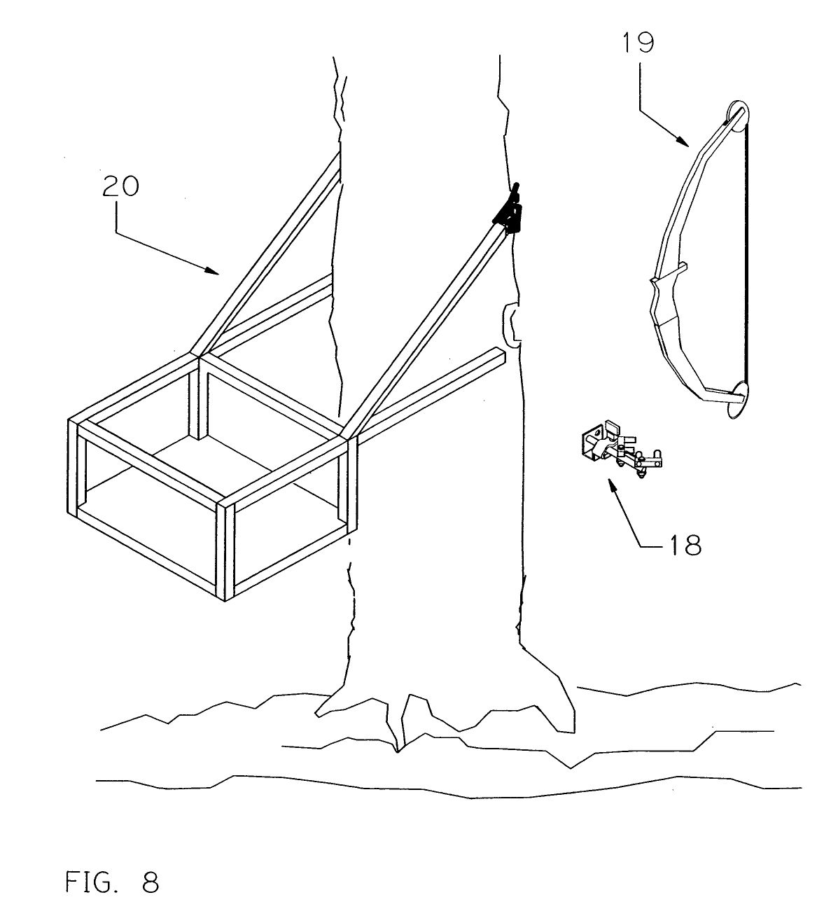

FIG. 9 provides a perspective view of the bow holder assembly mounted on a conventional tree stand and bow installed.

FIG. 10 provides a perspective view of the bow holder work table mounting bar.

FIG. 11 provides a perspective view of the bow holder assembly mounted to a work table.

### DETAIL DESCRIPTION OF THE INVENTION

The bow holder along with the ground stand and the work table mounting bar provide the archer the opportunity to optimize the use of a single bow holder in various situations. The bow holder has mechanical moving parts for receiving and releasing the bow which will become clearly understood when referring to the attached drawings and the following description. Bow holder assembly 18 and bow holder assembly 26 functions exactly the same. The differences between the two units are the various parts which may be intermixed within each assembly. When discussing the operation of either unit it is understood that the information also pertains to the operation of the other unit.

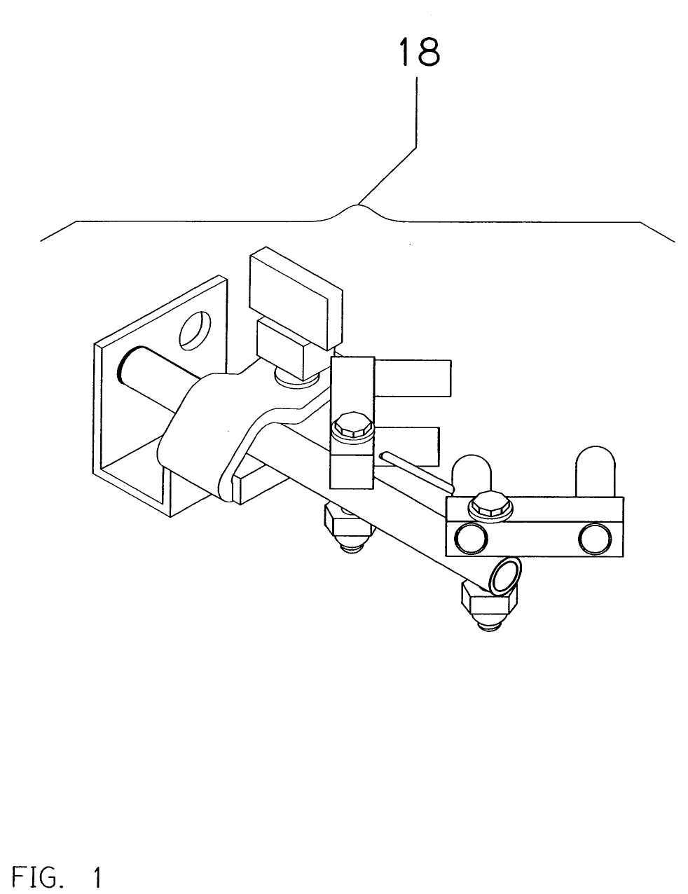

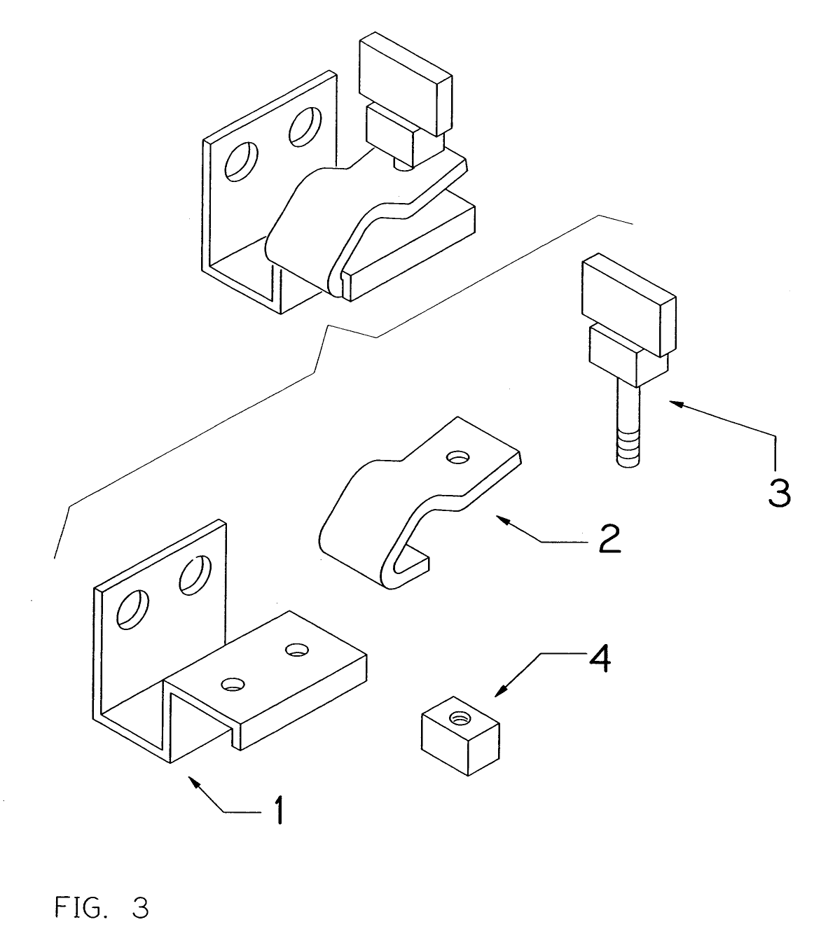

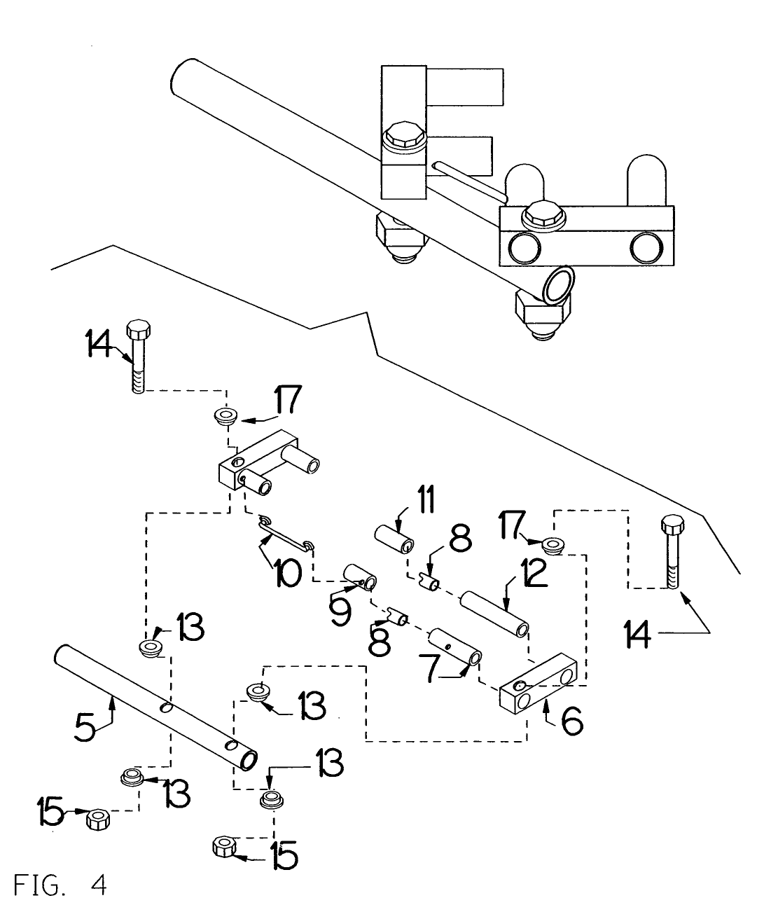

The bow holder assembly 18 shows the unit in its fully open position, as seen in FIG. 1. The explode view of the bow holder assembly 18 can be seen in FIG. 3 and FIG. 4. The mounting shaft 5 supports the block assembly 6 with the following components installed; long tube 12, long tube soft cover 11, short tube 7, short tube soft cover 9, as seen in FIG. 4. Adhesive 8 is used to secure the soft cover 9 and 11 over the short tube 7 and the long tube 12 respectfully. The short shoulder washer 13 and the long shoulder washer 17 are used to support and stabilize the rotation of the assembly block 6 and minimize any sound and friction the assembly block 6 may make when pivoting. The assembly block 6 is fastened to the mounting shaft 5 by use of a bolt 14 and a self locking nut 15. The elastic cord 10 maintains the block assembly 6 in its fully open position as seen in FIG. 1.

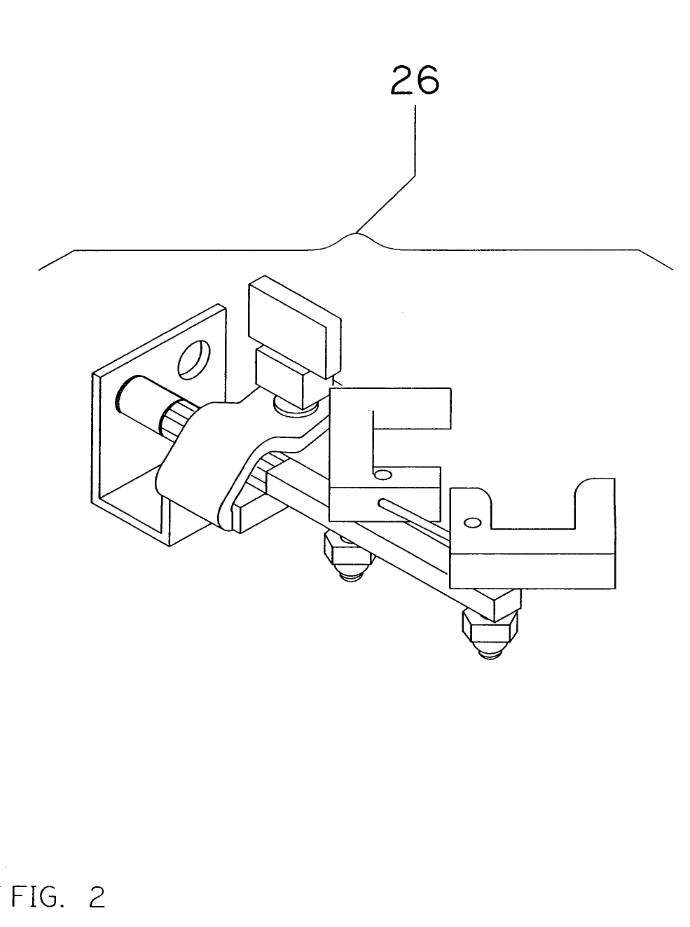

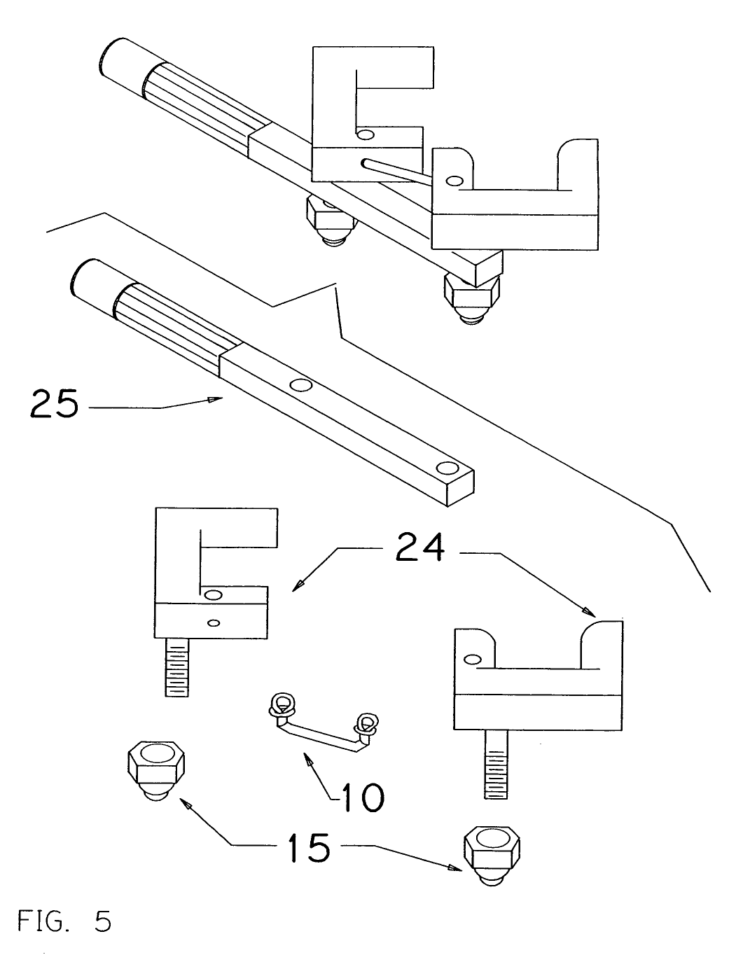

The bow holder assembly 26 shows the unit in its fully open position, as seen in FIG. 2. The explode view of the bow holder assembly 26 can be seen in FIG. 3 and FIG. 5. The mounting shaft 25 supports the arm assembly 24 with the following components installed, along with the elastic cord 10 and the securing nuts 15, as seen in FIG. 5. The elastic cord 10 maintains the arm assembly 24 in its fully open position as seen in FIG. 2.

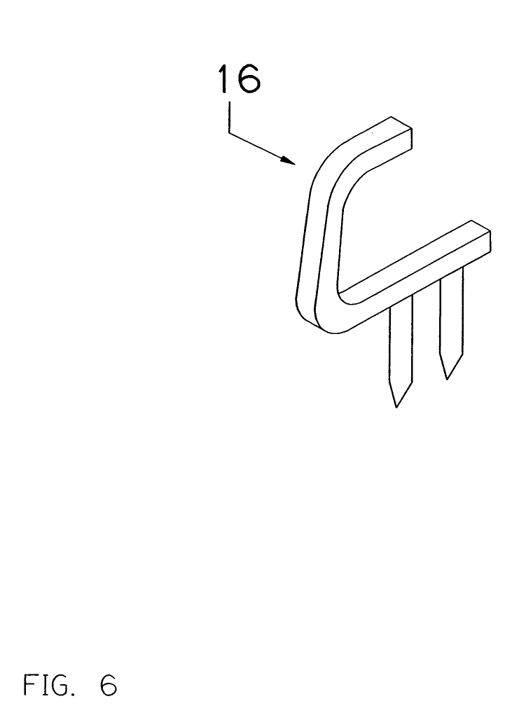

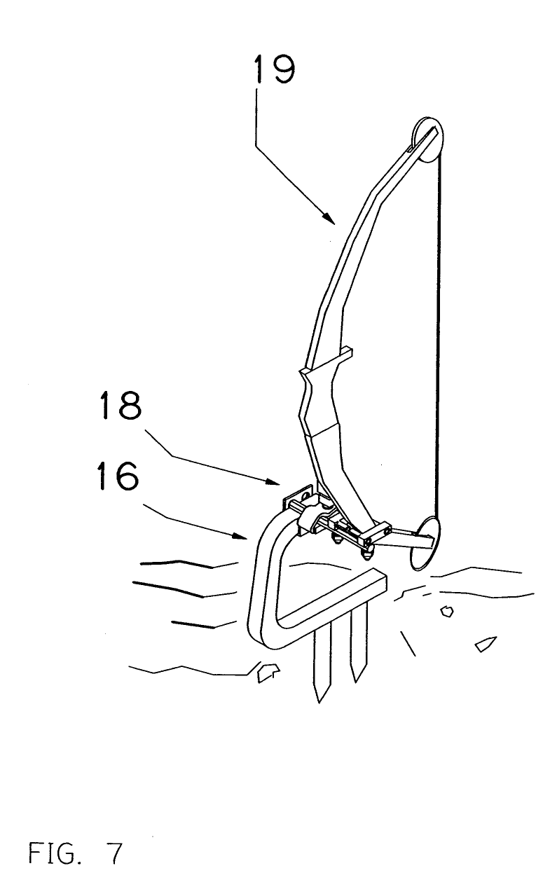

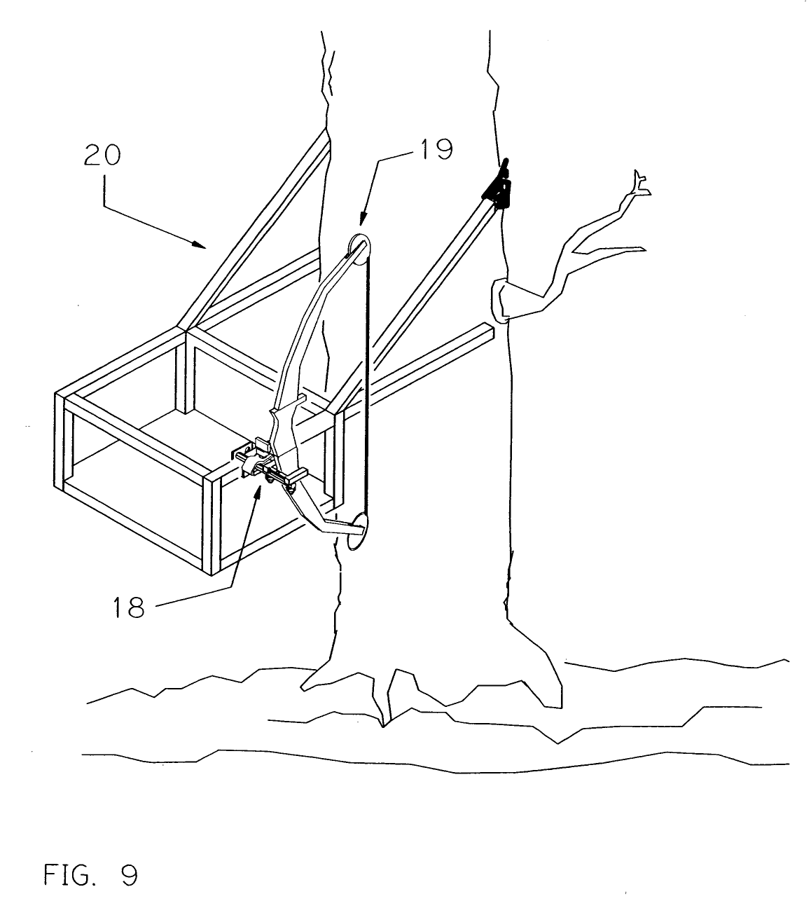

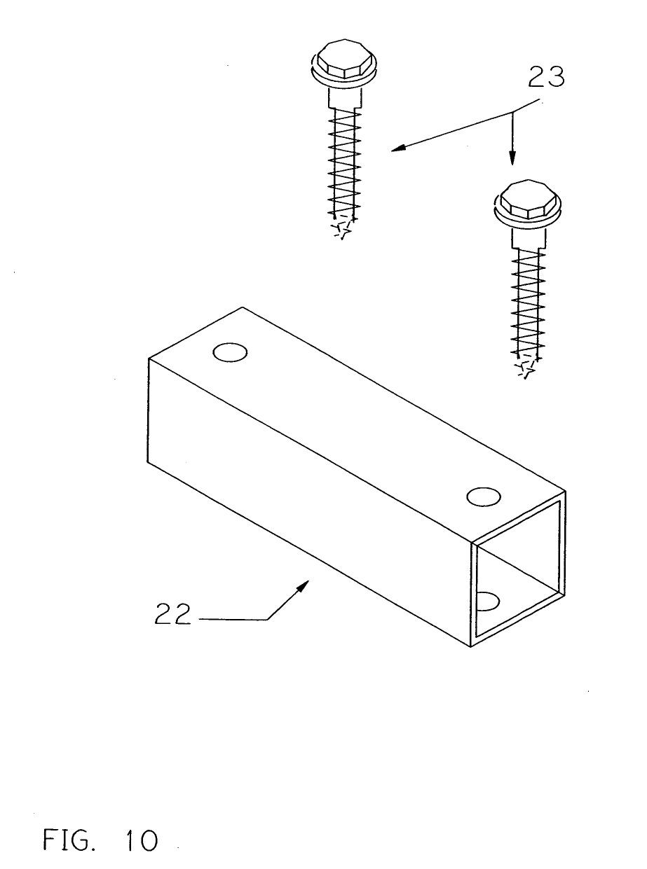

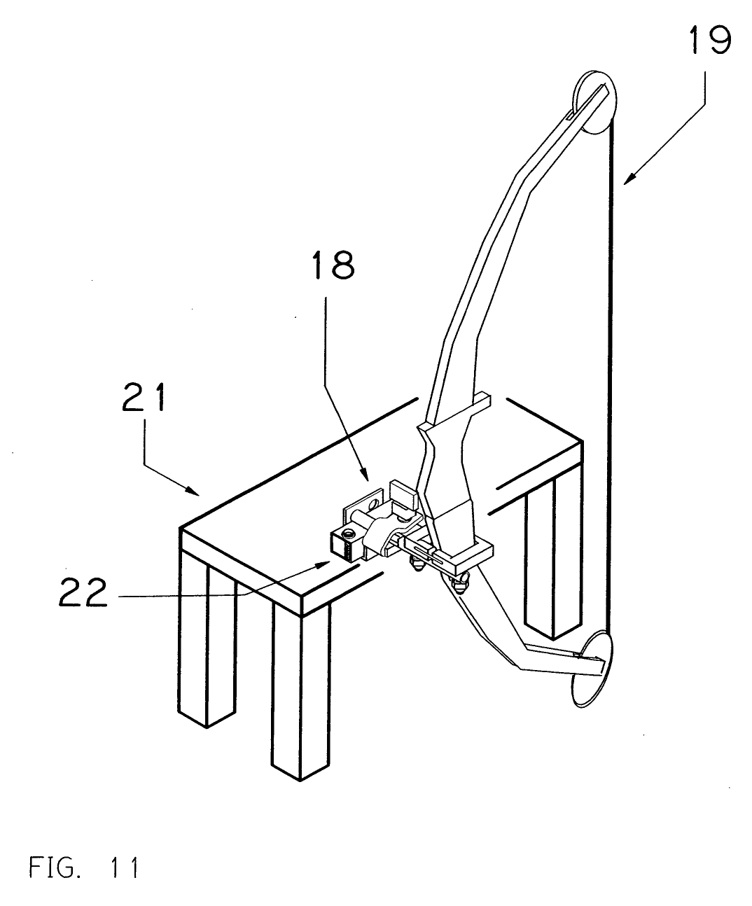

The rail bracket 1 is used to attach to a ground stand 16, as seen in FIG. 7, or a treestand 20, as seen in FIG. 9, or a work table mounting bar 22, as seen in FIG. 11. The rail bracket 1 is drilled so it may be used as either a left hand or right hand unit, as seen in FIG. 3. When the mounting shaft 5 is installed in the rail bracket 1 and the hold down clamp 2, clamp screw 3, and nut 4 are installed, they support and secure the bow holder assembly 18 to a treestand 20, or a ground stand 16, or a work table mounting bar 22. The mounting shaft 5 can be rotated to provide various angles needed to allow the bow 19 to be held within the arm assembly as seen in FIG. 7, FIG. 9, and FIG. 11. The hold down clamp 2, the screw clamp 3, and the nut 4 are used to apply the needed pressure to prevent the mounting shaft 5 from rotating when the bow 19 is installed. When either the ground stand 16, as seen in FIG. 6 or work table mounting bar 22 as seen in FIG. 10, are used to support the bow holder assembly 18, the bow holder 18 works in the same fashion as described above.

After mounting the bow holder assembly 18 to a fixture as referenced above, the bow 19 in its vertical orientation can be moved into and against the arm assembly. The force of the bow 19 will pivot and close the arm assembly 24. The bow 19 can be leaned forward which will lock the arm assembly 24 closed and secure the bow 19 from falling. The mounting shaft 5 can be rotated by losing the screw clamp 3 and then tightening it to provide the best angle of rest for the bow 19 and for use by the archer.

What is claimed is;

1. An archery bow holder that closes and opens as an archery bow is inserted in the bow holder arms which by the weight of the bow closes the arm assembly and in the reverse action the bow holder arm assembly automatically opens as the bow is being lifted out of the bow holder, comprising of: rail bracket, hold down clamp, thumb screw, locking nut, mounting shaft, parallel arms, elastic cord, ground stand, and work table mounting bar.

2. The archery bow holder of claim 1 wherein the bow holder and all of its components can be configured for either left hand or right hand installation and when configured to do so will operate the same as in either position.

3. The archery bow holder of claim 1 wherein the rail bracket provides the means of securing the bow holder to other apparatus.

4. The archery bow holder of claim 1 wherein the rail bracket provides means to secure and clamp the mounting shaft.

5. The archery bow holder of claim 1 wherein the rail bracket is made isometrically so it can be mounted either to the left or right hand side.

6. The archery bow holder of claim 1 wherein the hold down clamp is made to allow the mounting shaft to rotate as needed.

7. The archery bow holder of claim 1 wherein the hold down clamp is made to prevent the rotation of the mounting shaft when tighten down by the thumb screw.

8. The archery bow holder of claim 1 wherein the hold down clamp is made to align the mounting shaft properly when the bow holder is in either the left hand or right hand configuration.

9. The archery bow holder of claim 1 wherein the index mounting shaft is made to allow shaft rotation to predetermined angles.

10. The archery bow holder of claim 1 wherein the smooth mounting shaft is made to allow unlimited number of positions.

11. The archery bow holder of claim 1 wherein the mounting shaft is made for mounting either the arm assembly or monolithic arm assembly.

12. The archery bow holder of claim 1 wherein the arm assembly as attached to the mounting shaft stays open due to the pulling force of the elastic cord.

13. The archery bow holder of claim 1 wherein the arm assembly as attached to the mounting shaft will only close due to the force of the archery bow.

14. The archery bow holder of claim 1 wherein the arm assembly as attached to the mounting shaft will open when the weight of the archery bow is lifted.

15. The archery bow holder of claim 1 wherein the arm assembly has holes drill in each arm to feed the elastic cord through thereby connecting the two arms together to act simultaneous during opening process of the bow removal.

16. The archery bow holder of claim 1 wherein the ground stand provides two spikes that maintains the ground stand in the vertical position when in use.

17. The archery bow holder of claim 1 wherein the ground stand places the bow holder above and between the spikes to stabilized the ground stand.

18. The archery bow holder of claim 1 wherein the work table mounting bar provides a means to secure the bow holder to a table.

19. The archery bow holder of claim 1 wherein the work table mounting bar can be solid material or in the form of tubing.
